(19) United States
(12) Patent Application Publication
(10) Pub. No.: US 2023/0236323 A1
(43) Pub. Date: Jul. 27, 2023

(54) SLAM SYSTEM AND METHOD FOR VEHICLES USING BUMPER-MOUNTED DUAL LIDAR

(71) Applicant: PUKYONG NATIONAL UNIVERSITY INDUSTRY-UNIVERSITY COOPERATION FOUNDATION, Busan (KR)

(72) Inventors: Kyungchang LEE, Busan (KR); Jaeheon JANG, Busan (KR); Jungho KANG, Busan (KR); Hyeongjun KIM, Busan (KR); Hyunhee KIM, Busan (KR)

(73) Assignee: PUKYONG NATIONAL UNIVERSITY INDUSTRY-UNIVERSITY COOPERATION FOUNDATION, Busan (KR)

(21) Appl. No.: 18/085,147

(22) Filed: Dec. 20, 2022

(30) Foreign Application Priority Data
Jan. 26, 2022 (KR) 10-2022-0011500

(51) Int. Cl. G01S 17/931; G01S 17/89; G06T 7/73; G01S 7/481; G01S 7/497

(52) U.S. Cl. CPC G01S 17/931; G01S 17/89; G06T 7/73; G01S 7/4811; G01S 7/497; G06T 2207/10028

(57) ABSTRACT

There is provided a simultaneous localization and mapping (SLAM) system including a first LiDAR and a second LiDAR mounted on a vehicle bumper; a LiDAR data merge unit receiving data from the first LiDAR and the second LiDAR, aligning LiDAR times through time synchronization, and then converting the data into a point cloud type and merging the data; an electronic control unit (ECU) providing inertial data of the vehicle for correcting the data merged in the LiDAR data merge unit; and an SLAM unit correcting the data merged in the LiDAR data merge unit by using the inertial data of the vehicle received from the ECU to obtain LiDAR odometry for estimating a movement of the vehicle, generating a 3D map of a road on which the vehicle travels, and extracting a location and a traveling route of the vehicle inside a road.

### ACKNOWLEDGMENT

This work was supported by the Technology development Program (S3282183) funded by the Ministry of SMEs and Startups (MSS, Republic of Korea).

### CROSS-REFERENCE TO PRIOR APPLICATION

This application claims priority to Korean Patent Application No. 10-2022-0011500 (filed on Jan. 26, 2022), which is hereby incorporated by reference in its entirety.

### BACKGROUND

The present disclosure relates to a simultaneous localization and mapping (SLAM) for a vehicle, and more particularly, a SLAM system and method for a vehicle using a bumper-mounted dual laser imaging detection and ranging (LiDAR) and a bumper-mounted dual LiDAR that enables precise map creation and location recognition on an embedded board using inertial data of a vehicle electronic control unit (ECU) and a bumper-mounted dual LiDAR.

Most autonomous vehicles are classified into a total of six stages from manual driving stage having a level 0 to complete driving automation having a level 5 in which a vehicle directly drives without driver intervention in all situations, depending on the level of the vehicle's driving automation technology.

Currently, most autonomous vehicles are at a level 2, which is a partial driving automation level, to level 3, which is a level of autonomous driving, and research into autonomous driving at level 4 to level 5 at which systems directly judge and drive as a subject of driving in the near future has been conducted around the world.

A key technology for autonomous vehicles is advanced driver assistance systems (ADAS).

ADAS is divided into recognition, determination, and control, and radar, camera, and LiDAR are mostly used in the recognition part.

In recognition, an environment in which a vehicle is driving is recognized and collected as data, and proceeds with filtering, marking, and labeling for a next step, determination.

A judgment unit analyzes and classifies a flow of traffic around the vehicle, the existence of obstacles around the vehicle, a lane and road the vehicle is currently driving on, etc. with the information collected by each sensor, and plays a role, such as creating a route for safe driving of the vehicle and heading to a destination.

Lastly, a controller is a portion that performs actual driving and control of the vehicle, driving along an optimal route calculated through recognition and judgment, and avoiding obstacles, and a portion that controls the vehicle directly using steering, deceleration/acceleration, and braking of the vehicle.

Recognition, the first of the three portions of ADAS, plays a very important role in configuring ADAS. Recognition of a problem is a first step towards solving a problem, and judgment and control are performed based on recognition. Therefore, research for accurate recognition continues to be regarded as an important research subject and continues to be studied.

Among the recognition technologies for autonomous driving, positioning, that is, a location of a vehicle, is a very important part. In order for a vehicle to safely drive toward a destination, avoid a recognized obstacle or stop, accurate positioning for the vehicle's surroundings and location is essential.

In the past, GPS was most often used to measure a position of a vehicle. GPS is a method of positioning a position of a vehicle using satellite signals, and has the advantage that a position of a vehicle may be received anywhere from a position where the sky is visible and GPS is currently installed in most vehicles.

However, GPS generally has an error of 10 to 15 m, and it is possible to precisely measure a position using DGPS, but it has a problem that a large cost is incurred therefor.

In addition, the GPS has disadvantages, such as a multi-path fading phenomenon which occurs due to poor signal stability in high-rise building areas, signal disconnection, and reception performance deterioration in tunnels or underground areas.

In general, precision maps used for autonomous driving provide a lot of data, such as signs installed near the road, traffic lights on the road, lanes and center lines, but GPS with an error of 10 to 15 m has limitations in use.

In order to solve this problem, research on a location recognition technique that recognizes a location of an actual vehicle by mounting additional sensors, such as a LiDAR, a camera, and a radar on the vehicle has been conducted.

There are also many issues to consider about where to install these sensors.

Currently, sensor installation for most autonomous vehicles is equipped with LiDAR and cameras on top of the vehicle, which is advantageous for acquiring data, and a large number of additional sensors are mounted on the outside of the vehicle.

This affects the aerodynamics of the vehicle, adversely affecting fuel efficiency of the vehicle, and there is a high possibility that the sensor may be detached from a fixing device due to an accident or vibration to cause a secondary accident.

In addition, due to the aerodynamic characteristics of the vehicle, the air of the vehicle passes through a windshield and passes through a roof of the vehicle. At this time, external contaminants or debris, such as stones, are directed toward the roof, resulting in damage or contamination of the LiDAR installed on the roof.

In the case of the sensor mounted on the roof, if it falls off, it is likely to fall in front of a vehicle that follows, which may lead to fatal consequences.

Meanwhile, in the case of SLAM of the related art, a map was created using 2D LiDAR, such as Gmapping, Hector SLAM, Karto SLAM, etc., which is a slam using 2D LiDAR, and navigation was performed through the created map.

These 2D SLAM and navigation have limitations in detecting obstacles due to the simplicity of recognizing the surrounding environment, and also have limitations in detecting obstacles or dynamic objects.

As another method, loop matching was implemented even with limited data through a scan matching method through point cloud data of 2D LiDAR and roughness judgment data in a local area, and accumulated errors were continuously eliminated through continuous loop closure to perform SLAM in an outdoor environment.

SLAM is an abbreviation of simultaneous localization and mapping, and as the name suggests, it is a process of creating a map while continuously tracking a location in an unknown environment.

However, 2D maps are difficult to provide sufficient information required for autonomous driving of vehicles, and there are limitations to the application of SLAM for vehicles, which requires recognition of the surrounding environment as well as route recognition.

Therefore, the need for 3D recognition of the surrounding environment and obstacles has been constantly demanded.

Based on the demand, DL-SLAM, which is a 2.5D SLAM, has been developed. In the case of such a 2.5D SLAM, since calculation is performed with fewer features than a 3D point cloud, SLAM was possible with relatively less computational power, and a map was advantageously created through loop closure through segment feature extraction.

However, in 2.5D SLAM, such as DL-SLAM, due to the problem of height invariance, effectiveness in dynamic environments was reduced, and segment robustness also had room for improvement.

SLAM using LiDAR and cameras in autonomous vehicles has been studied to replace GPS to precisely locate a vehicle.

In an effort to this end, probabilistic estimation-based technology, such as KF (Kalman Filter) were initially introduced, but this was extended to EKF (Extended Kalman Filters) and extended to unscented Kalman Filters (UKF) for nonlinear systems for application in non-linear environments. In addition, particle filters, such as Rao-Blackwellized and Monte Carlo, rather than Kalman filters, also had a great influence on SLAM. However, it is difficult to guarantee consistent performance in the case of SLAM outdoors where various environments are mixed in the method using only these filters.

Therefore, as technologies such as machine learning and deep learning have recently developed, algorithms such as CNN-SLAM, which is an approach that applies learning to autonomous driving for new vehicles, have emerged. This showed the possibility that it is possible to detect a robot's pose or position with only two images from a moving vehicle with a monocular camera.

Although this approach is very promising, it has some drawbacks.

In the case of SLAM based on deep learning, a GPU is essential, and the use of GPU in a vehicle incurs very large cost and power consumption.

In addition, in the case of deep learning-based SLAM, the difficulty of finding answers to infinite data still remains as the real environment changes every hour and every minute.

Therefore, there is demand for the development of new technologies and efficient SLAM technology to solve the safety problem of the roof-mounted LiDAR and supplement a decrease in precision due to loss of a viewing angle of the bumper-mounted LiDAR.

### RELATED ART DOCUMENT

### Patent Document

(Patent Document 1) Korean Patent Laid-Open Publication No. 10-2018-0100835
(Patent Document 2) Korean Patent Laid-Open Publication No. 10-2020-0109116
(Patent Document 3) Korean Patent Laid-Open Publication No. 10-2021-0015211.

### SUMMARY

In view of the above, the present disclosure provides a SLAM system and method for a vehicle using a bumper-mounted dual LiDAR, capable of performing precise map creation and location recognition in an embedded board using inertial data of a vehicle ECU and a bumper-mounted dual LiDAR.

In order to solve an aerodynamic problem and the drop-off problem caused by a LiDAR mounted on a roof of a vehicle, the present disclosure provides a SLAM system and method for a vehicle using a bumper-mounted dual LiDAR, in which two LiDARs are mounted on a bumper to efficiently create a three-dimensional (3D) map through SLAM.

The present disclosure provides a SLAM system and method for a vehicle using a bumper-mounted dual LiDAR, capable of integrating data of two LiDARs mounted on a vehicle bumper, processing the data with one time and a unified coordinate system, receiving the same, extracting information on a traveling route of the vehicle, performing correction using inertial data of the vehicle output from an ECU inside the vehicle, and initiating point cloud data of LiDAR along a movement route to create a precise map without adding a sensor.

Other objects of the present disclosure are not limited to the above-mentioned objects, and other objects not mentioned will be clearly understood by those skilled in the art from the following description.

According to an aspect, a simultaneous localization and mapping (SLAM) system for a vehicle using a bumper-mounted dual LiDAR includes: a first LiDAR and a second LiDAR mounted on a vehicle bumper to output data for map creation and location recognition; a LiDAR data merge unit receiving data from the first LiDAR and the second LiDAR, aligning LiDAR times through time synchronization, and then converting the data into a point cloud type and merging the data; an electronic control unit (ECU) providing inertial data of the vehicle for correcting the data merged in the LiDAR data merge unit; and an SLAM unit correcting the data merged in the LiDAR data merge unit by using the inertial data of the vehicle received from the ECU to obtain LiDAR odometry for estimating a movement of the vehicle, generating a 3D map of a road on which the vehicle travels, and extracting a location and a traveling route of the vehicle inside a road.

According to another aspect, a simultaneous localization and mapping (SLAM) method for a vehicle using a bumper-mounted dual LiDAR includes: receiving data for map creation and location recognition from a first LiDAR and a second LiDAR mounted on a vehicle bumper, aligning LiDAR times through time synchronization, and then converting the data into a point cloud type and merging the data; receiving inertial data of the vehicle and obtaining LiDAR odometry for estimating a movement of the vehicle using point clouds recognized by the first LiDAR and the second LiDAR; and generating a 3D point cloud map by registering the LiDAR point cloud in a global map according to the obtained odometry by performing SLAM using acceleration data output in a CAN format from an electronic control unit (ECU) inside the vehicle in order to increase precision of odometry and reduce the time required for calculation.

As described above, the SLAM system and method for a vehicle using a bumper-mounted dual LiDAR according to the present disclosure have the following effects.

First, precise map creation and location recognition may be made in an embedded board using inertial data of a vehicle ECU and a bumper-mounted dual LiDAR.

Second, in order to solve the aerodynamic problem and drop-off problem caused by the LiDAR mounted on a roof of a vehicle, two LiDARs may be mounted on a bumper to efficiently create a three-dimensional (3D) map through SLAM.

Third, by integrating data of two LiDARs mounted on a vehicle bumper, processing the data with one time and a unified coordinate system, receiving the same, extracting information on a traveling route of the vehicle, performing correction using inertial data of the vehicle output from an ECU inside the vehicle, and initiating point cloud data of LiDAR along a movement route, a precise map may be created without adding a sensor.

### BRIEF DESCRIPTION OF THE DRAWINGS

FIGS. 1A and 1B are configuration diagrams of a simultaneous localization and mapping (SLAM) system for a vehicle using a bumper-mounted dual LiDAR according to the present disclosure.

FIG. 2 is a flowchart illustrating a SLAM method for a vehicle using a bumper-mounted dual LiDAR according to the present disclosure.

FIG. 3 is a configuration diagram showing a LiDAR data matching process.

FIG. 4 is a configuration diagram showing a process of applying ECU data.

FIG. 5 is a configuration diagram showing the entire data flow in a SLAM system for a vehicle using a bumper-mounted dual LiDAR according to the present disclosure.

FIGS. 6A and 6B are configuration diagrams showing a LiDAR range and features measured in a LiDAR installed in a bumper.

FIGS. 7A and 7B are configuration diagrams showing a LiDAR range and features measured in a LiDAR installed on a roof.

FIGS. 8A and 8B are configuration diagrams showing a LiDAR range and features measured in a dual LiDAR installed on a bumper.

FIG. 9 is a configuration diagram showing a difference in odometry between a single LiDAR (left) of a roof and a dual LiDAR (right) of a bumper.

FIG. 10 is a configuration diagram showing an error of a dual LiDAR compared to a single LiDAR of a roof.

FIG. 11 is a configuration diagram showing LiDAR point cloud raw data for feature change confirmation.

FIG. 12 shows edge: 1, planar: 1 (left), edge: 1, planar: 2 (right) per sub-image (60°).

FIG. 13 is a configuration diagram showing a vehicle initial route difference according to the presence or absence of ECU data.

FIG. 14 is a configuration diagram showing a difference in initial values according to the presence or absence of ECU data.

FIGS. 15A and 15B are diagrams of a traveling route and a completed map according to a first embodiment to which the present disclosure is applied.

FIGS. 16A and 16B are diagrams of a traveling route and a completed map according to a second embodiment to which the present disclosure is applied.

FIGS. 17A and 17B are diagrams of a traveling route and a completed map according to a third embodiment to which the present disclosure is applied.

### DETAILED DESCRIPTION

Hereinafter, an embodiment of a simultaneous localization and mapping (SLAM) system and method for a vehicle using a bumper-mounted dual LiDAR according to the present disclosure will be described in detail.

Features and advantages of the SLAM system and method for a vehicle using a bumper-mounted dual LiDAR according to the present disclosure will become clear through detailed description of each embodiment below.

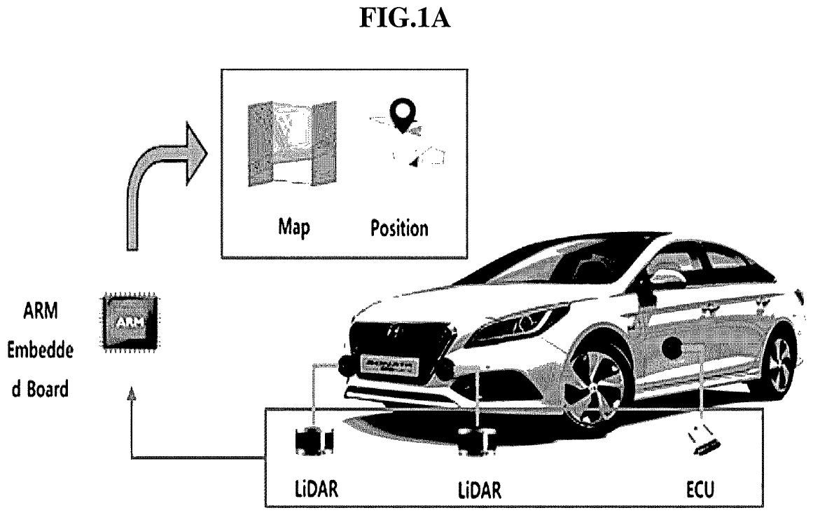

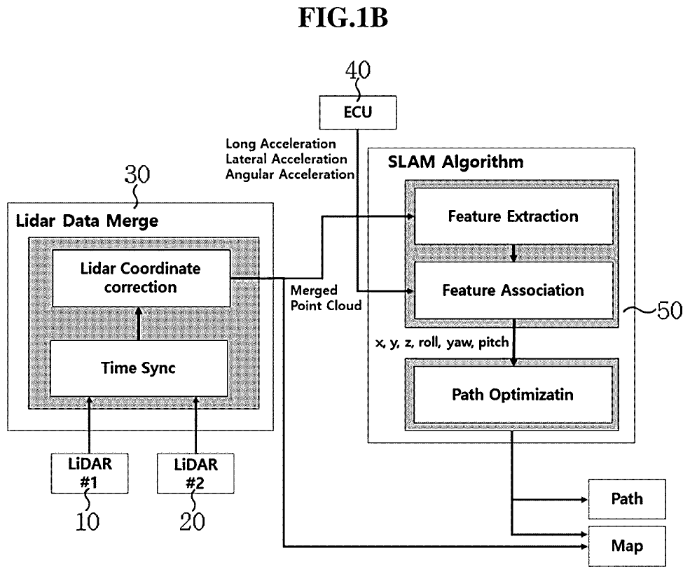

FIGS. 1A and 1B are configuration diagrams of a SLAM system and method for a vehicle using a bumper-mounted dual LiDAR according to the present disclosure.

Although the terms used in this specification are selected, as much as possible, from general terms that are widely used at present while taking into consideration the functions of the elements obtained in accordance with one embodiment, these terms may be replaced by other terms based on intentions of those skilled in the art, customs, emergence of new technologies, or the like. In addition, in certain instances, terms that are arbitrarily selected by the applicant may be used. In this case, meanings of these terms will be disclosed in detail in the corresponding part of the description of the invention. Accordingly, the terms used herein should be defined based on practical meanings thereof and the whole content of this specification, rather than based on names of the terms.

Throughout the specification, unless explicitly described to the contrary, the word “comprise” and variations such as “comprises” or “comprising”, will be understood to imply the inclusion of stated elements but not the exclusion of any other elements. Further, in the present disclosure, a ‘module’ or a ‘unit’ performs at least one function or operation and may be implemented by hardware or software or a combination of the hardware and the software.

In particular, units processing at least one function or operation may be implemented as an electronic device including at least one processor, and at least one peripheral device may be connected to the electronic device according to a method of processing the function or operation. Peripheral devices may include a data input device, a data output device, and a data storage device.

A SLAM system and method for a vehicle using a bumper-mounted dual LiDAR according to the present disclosure enables precise map creation and location recognition in an embedded board using bumper-mounted dual LiDAR and inertial data of a vehicle ECU.

To this end, in order to solve an aerodynamic problem and the drop-off problem caused by a LiDAR mounted on a roof of a vehicle, the present disclosure may include a configuration in which two LiDARs are mounted on a bumper to efficiently create a three-dimensional (3D) map through SLAM.

As shown in FIG. 1A, the present disclosure may include a configuration capable of integrating data of two LiDARs mounted on a vehicle bumper, processing the data with one time and a unified coordinate system, receiving the same, extracting information on a traveling route of the vehicle, performing correction using inertial data of the vehicle output from an ECU inside the vehicle, and initiating point cloud data of LiDAR along a movement route to create a precise map without adding a sensor.

As shown in FIG. 1B, an SLAM system for a vehicle using a bumper-mounted dual LiDAR according to an embodiment of the present disclosure includes a first LiDAR 10 and a second LiDAR 20 mounted on a vehicle bumper to output data for map creation and location recognition, a LiDAR data merge unit 30 receiving data from the first LiDAR 10 and the second LiDAR 20, aligning LiDAR times through time synchronization, and then converting the data into a point cloud type and merging the data, an electronic control unit (ECU) 49 providing inertial data of the vehicle for correcting the data merged in the LiDAR data merge unit 30, and an SLAM unit 50 correcting the data merged in the LiDAR data merge unit 30 by using the inertial data of the vehicle received from the ECU to obtain LiDAR odometry for estimating a movement of the vehicle, generating a 3D map of a road on which the vehicle travels, and extracting a location and a traveling route of the vehicle inside a road.

Here, raw data of each of the first LiDAR 10 and the second LiDAR 20 is expressed as one integrated coordinate through point cloud merge. A relative position difference between sensors is obtained in an integrated coordinate system and applied to align all point clouds with the sensors in the corrected coordinate system as the origin.

At this time, the raw data generated by the LiDARs is received through UDP, and the data of each of the two LiDARs is stored in a buffer, and after times of the LiDARs are aligned through time synchronization, the data is converted into a point cloud type and merged.

Here, the point cloud is a type of data mainly collected by LiDAR and RGB-D sensors (depth cameras). These sensors send light, ultrasound, or a laser to an object, measure a time for which reflected light, ultrasound or laser is returned, and calculate a distance per signal to generate one point. This is performed repeatedly or simultaneously according to the resolution of the sensor to generate a large number of points. The number of generated points varies depending on the precision of the sensor, but a point cloud refers to a set cloud of numerous points spread in a 3D space.

Such a point cloud is arranged in a 3D array based on the sensor, and since each point has data (depth), the points are automatically rotated and arranged based on the sensor even without considering scale or rotation of the points in utilizing the data, so that vast amounts of point cloud data may be easily used.

In the SLAM system for a vehicle using a bumper-mounted dual LiDAR, a map and location is with the LiDAR mounted on the vehicle bumper and inertial information output from the inside of the vehicle.

For the safety of the vehicle traveling on the road, it is preferable to mount the LiDAR through an aluminum profile and a separate mount on the bumper of the vehicle.

In order to expand a recognition range of the LiDAR in the bumper of the vehicle, an operation of merging point cloud data in each LiDAR is performed using two LiDARs LiDAR odometry that estimates a movement of the vehicle using the point cloud recognized by LiDAR is obtained.

In order to increase the precision of odometry and reduce the time required for calculation, SLAM is performed using vehicle acceleration data output in a CAN format from the ECU inside the vehicle.

A SLAM method for a vehicle using a bumper-mounted dual LiDAR according to the present disclosure is as follows.

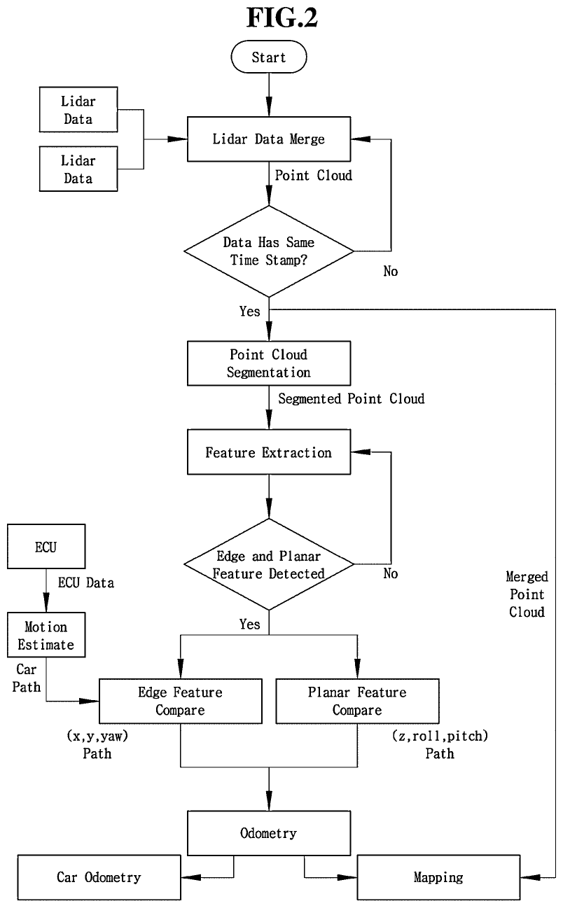

FIG. 2 is a flowchart showing a SLAM method for a vehicle using a bumper-mounted dual LiDAR according to the present disclosure.

The vehicle SLAM method using the bumper-mounted dual LiDAR according to the present disclosure includes receiving data for map creation and location recognition from the first LiDAR 10 and the second LiDAR 20 mounted on a vehicle bumper, aligning LiDAR times through time synchronization, and then converting the data into a point cloud type and merging the data, receiving inertial data of the vehicle and obtaining LiDAR odometry for estimating a movement of the vehicle using point clouds recognized by the first LiDAR 10 and the second LiDAR 20, and generating a 3D point cloud map by registering the LiDAR point cloud in a global map according to the obtained odometry by performing SLAM using acceleration data output in a CAN format from an ECU inside the vehicle in order to increase precision of odometry and reduce the time required for calculation.

Taking the safe driving of the vehicle into consideration, two LiDARs are mounted on the bumper of the vehicle, and SLAM is performed with data output from the vehicle ECU to increase applicability of SLAM performed in the vehicle and to secure versatility.

SLAM is performed by inputting an output from the LiDAR merging system merging point cloud data of dual LiDAR and longitudinal acceleration, lateral acceleration, and yaw rate of the vehicle in a traveling environment to an embedded control board through the ECU of the vehicle.

Odometry for SLAM is obtained through matching between LIDAR scans, and an initial value at this time is calculated through ECU data. According to the odometry obtained through this process, the LiDAR point cloud is registered in a global map to create a 3D point cloud map.

The input of the dual LiDAR is described in detail as follows.

Unlike mobile robots or AGVs, vehicles travel at high speeds, so the aerodynamic design of vehicles is very important in terms of both vehicle driving stability and vehicle fuel efficiency.

In addition, when an accident occurs, depending on a location of the mounted LiDAR, loss of the sensor may cause human injury or secondary accidents. Therefore, the LiDAR of the vehicle should be mounted on the bumper of the vehicle, not on the roof as is the case in most cases.

However, when the LIDAR is mounted on the bumper, a viewing angle is limited, unlike when it is installed on the roof of the vehicle. Therefore, two LiDARs are installed in the bumper to secure a maximum viewing angle in the bumper.

Raw data of each LiDAR is expressed as one integrated coordinate through point cloud merge.

In the integrated coordinate system, a relative position difference between the sensors is obtained and applied to align all point clouds with the sensor in the corrected coordinate system as the origin.

At this time, the raw data generated by the LiDAR is received through UDP, and the data of each of the two LiDARs is stored in a buffer, and after times of the LiDARs are aligned through time synchronization, the data is converted into a point cloud type and merged.

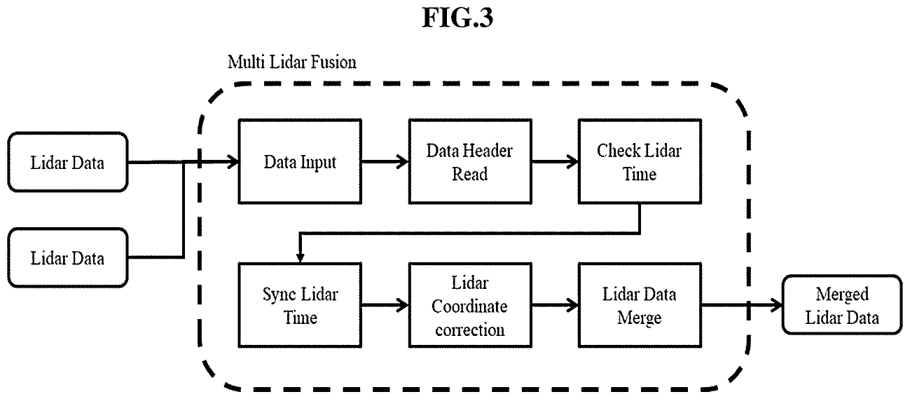

FIG. 3 is a configuration diagram showing a LiDAR data matching process.

The odometry of the vehicle is obtained using LiDAR point cloud data, and the odometry is calculated through matching between scans using features detected from LiDAR scans.

In order to reduce the number of point clouds used for detection and minimize a load in the embedded board, clustering of the input point clouds is performed.

In clustering, a cluster with less than 30 points is not trusted and not registered, and through this process, points such as discontinuous noise, such as small objects, such as leaves and paper shaking in the wind are filtered out and only a reliable point such as tree trunks and poles is left.

Thereafter, for feature extraction, smoothness of each point is calculated and classified into edge and planar.

In order to uniformly extract the calculated features, a scan area is divided into 6 sub-areas, and edge and planar extraction is performed for each area.

Thereafter, correspondence of the features between two consecutive scans is calculated to obtain the odometry.

Finally, the odometry is obtained by calculating a transform matrix between the features having correspondence. At this time, in order to solve the transform matrix as an optimization problem, if a distance of the correspondence becomes close, it means that registration has been properly performed, and optimization is performed with edge correspondence and planar correspondence as costs.

A process of applying ECU data is described as follows.

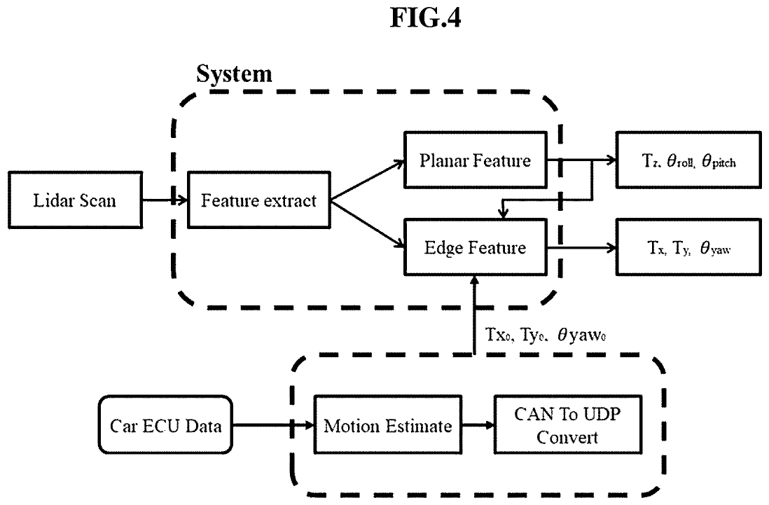

FIG. 4 is a configuration diagram illustrating a process of applying ECU data.

In the present disclosure, in order to calculate the odometry of SLAM, the odometry is calculated through an optimization technique with the distance of the feature obtained through LIDAR scan as a cost.

In the case of a vehicle traveling on the ground, there is only a change in altitude along the road in the case of a z-axis, which is perpendicular to the ground. Therefore, the change of the z-axis in the odometry of the vehicle and the roll and pitch are measured through matching between the scans measured by LiDAR.

However, when calculating a movement of the vehicle in x and y directions on the road, a route estimation value is provided using imu data of the vehicle to complement the odometry calculation.

Data on longitudinal acceleration Tₓ, lateral acceleration T_{y}, and θ_{yaw} rate are output from the ECU of the vehicle, based on which Tₓ, T_{y}, θ_{yaw}, which are x, y-axis movement and yaw rotation of the vehicle, are corrected.

As shown in FIG. 4, the present disclosure uses vehicle ECU data to estimate a movement route of the vehicle.

An embedded environment establishment and sensor installation in a vehicle are described as follows.

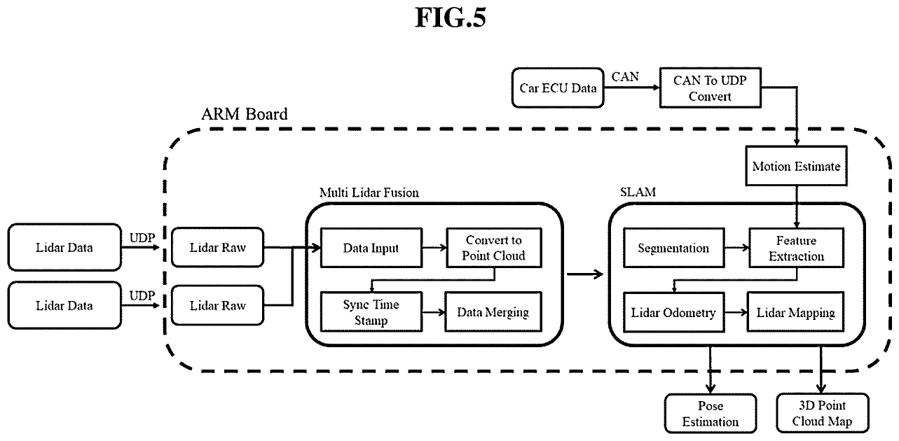

FIG. 5 is a configuration diagram showing the entire data flow in a SLAM system and method for a vehicle using a bumper-mounted dual LiDAR according to the present disclosure.

Most of the currently researched LiDAR data confirmation, range setting, SLAM, mapping, and map registration have been performed on the middleware called ROS in the PC environment. However, in the present disclosure, both LIDAR and SLAM used to implement SLAM that is directly executed in a vehicle are executed on an embedded board for a vehicle.

ROS is middleware that runs on an OS, such as Ubuntu, and provides communication between nodes of each program and time synchronization using ROS Time, but the use of TCP/IP in communication and various visualization and simulation tools are not required in the vehicle and only causes an increase in the amount of computation.

The board used in an embodiment of the present disclosure is a vehicle embedded board using an ARM processor, and includes an Ethernet (RJ45) input unit and a CAN input unit.

Therefore, the LiDAR input is received as UDP through an Ethernet port, and in the case of the IMU, CAN data of the ECU is converted through CANoe into a desired unit standard, and then transmitted to the embedded board through UDP again. By implementing this structure in the embedded board, the actual map and vehicle route are output so that they may be actually driven and applied to the vehicle.

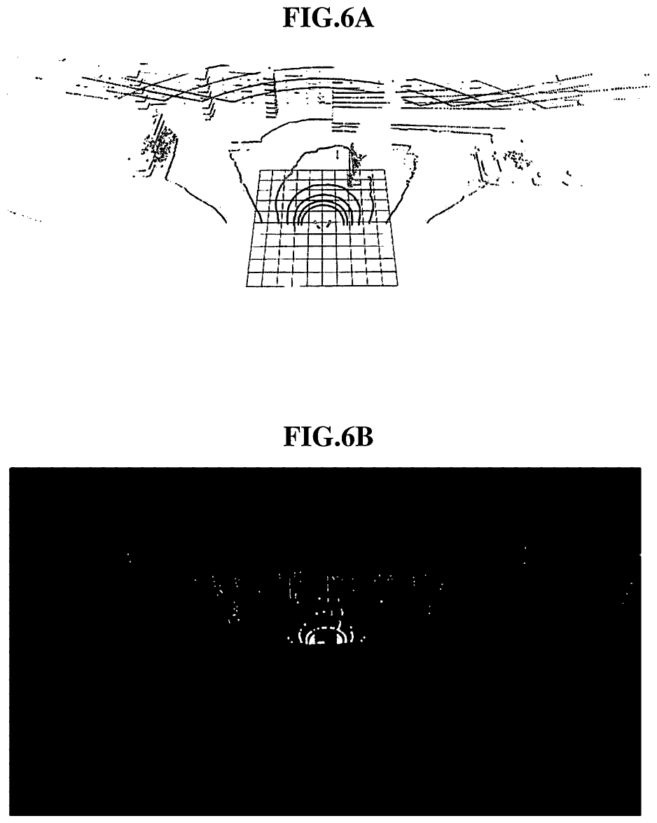

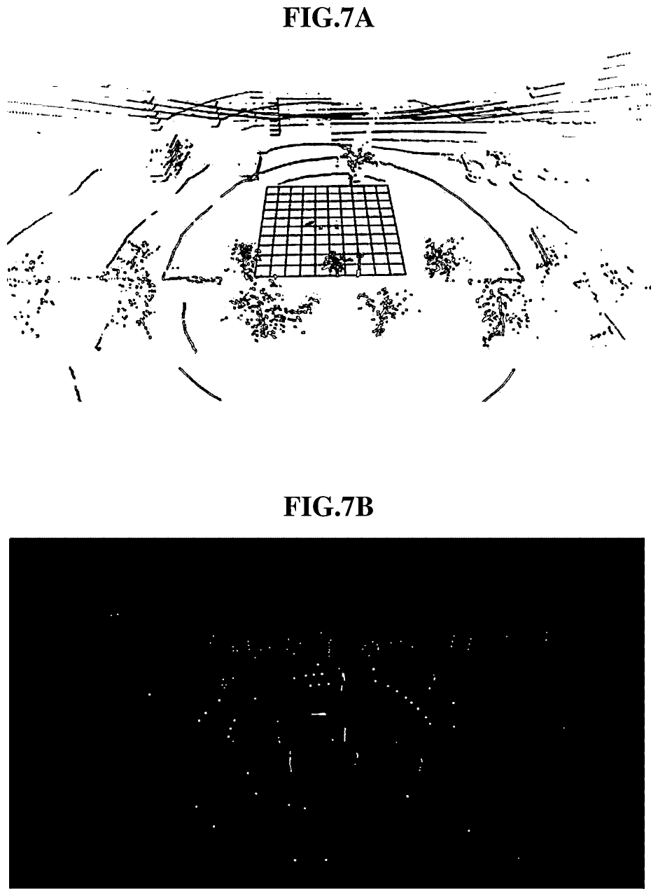

FIGS. 6A and 6B are configuration diagrams showing LiDAR ranges and features measured from a LiDAR installed in the bumper, and FIGS. 7A and 7B are configuration diagrams showing LiDAR ranges and features measured from a LiDAR installed on a roof.

The performance evaluation results of the SLAM system and method for a vehicle using a bumper-mounted dual LiDAR according to the present disclosure are as follows.

For a LiDAR used for performance evaluation, Velodyne's VLP-16 model was used. T VLP-16 model has 16 Z-direction channels and may detect 360°. In the experiment, LiDAR scan was performed at 10 Hz, and at this time, x-axis resolution of each point was 0.2°, and 1800 points over 360° were measured in a single channel.

The results of the viewing angle difference according to the position of the LiDAR are shown in Table 1.

TABLE 1

| | roof | bumper |
|---|---|---|
| viewing angle | 360° | 178° |
| detected feature | 18 | 10 |
| scan channel of | 5 | 7 |
| floor surface | | |

For comparison of the viewing angles, viewing angles measured for 1 second were compared while objects, such as trees, pillars, and walls of buildings therearound were stopped at sufficient positions.

The number of objects output from the LiDAR indicated only objects that could be distinguished with the naked eye. In the case of the viewing angle, omnidirectional recognition was possible on the roof, but when mounted on the bumper, only the front (178°) of the vehicle was recognized.

In addition, even in the case of recognized objects, it may be confirmed that a recognition rate in the bumper is low, with the object recognition rate ranging from roof: 18 to bumper: 10 due to the restriction of the narrow viewing angle.

Finally, it can be seen that, among the 16 channels, the number of scans for the floor surface when leveling with the ground is 7 for the bumper and 5 for the roof, and the roof has a lower number than the bumper, and this is because some channels scan too far away when the LiDAR is installed on the roof, which is higher than that installed in the bumper.

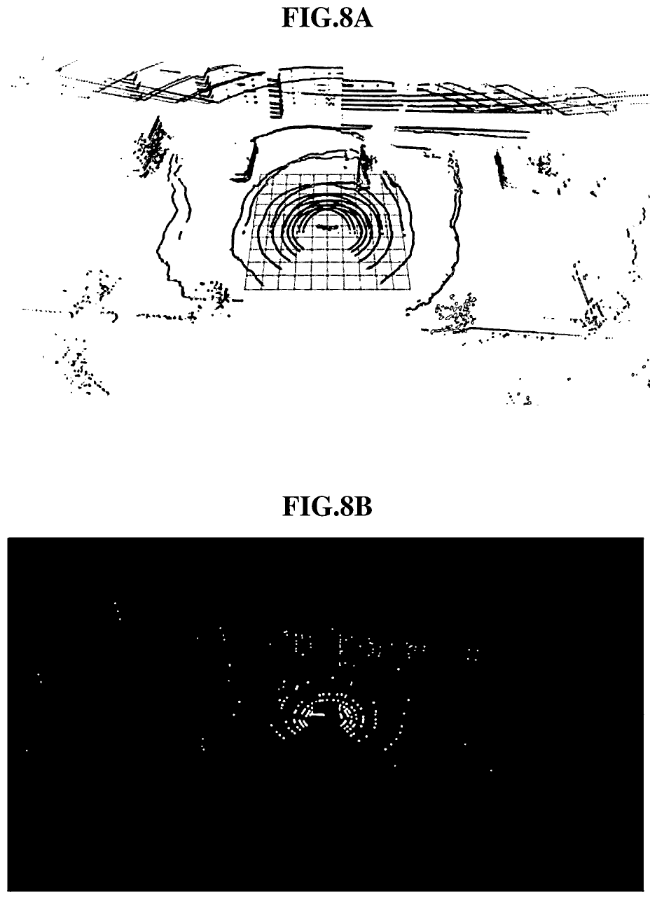

FIGS. 8A and 8B are configuration diagrams showing LiDAR ranges and features measured in a dual LiDAR installed in a bumper.

Comparison between the use of one LiDAR and the use of two LiDARs to compensate for the low viewing angle in the bumper is as follows.

TABLE 2

| | single LiDAR | dual LiDAR |
|---|---|---|
| viewing angle | 178° | 290° |
| detected feature | 10 | 14 |
| scan channel of | 7 | 7 |
| floor surface | | |

TABLE 3

| | single LiDAR | dual LiDAR |
|---|---|---|
| before enter corner | 4 | 7 |
| during cornering | 2 | 5 |
| immediately before | 1 | 3 |
| existing corner | | |

In the case of using two LiDARs, each is installed on the corner of each bumper, a central portion along a streamlined design of the bumper overlaps, and a portion of the rear toward the end of the bumper may be recognized.

Therefore, the viewing angle increased by 110° compared to when one LIDAR was installed. As a result, it can be seen that the number of objects recognized is also 14, an increase of 4 compared to the existing single LiDAR.

This additional posterolateral view expands the range in which trees, pillars, and corners of buildings passing by the vehicle may be recognized as features in matching between scans when extracting the odometry of the vehicle.

In addition, when a vehicle makes a left or right turn, measurement may be made for a relatively long time until the feature is lost, and the feature of the turning direction may be maintained even after exiting a corner, which is advantageous for tracking the vehicle's rotation in odometry.

Due to the difference in mounting height, the LiDAR mounted on the bumper is more advantageous in detecting an object in front of the vehicle than the LiDAR installed on the roof.

In FIG. 8B, it may be seen that a block in a front flower bed, which was not detected in the LiDAR installed on the roof, was detected.

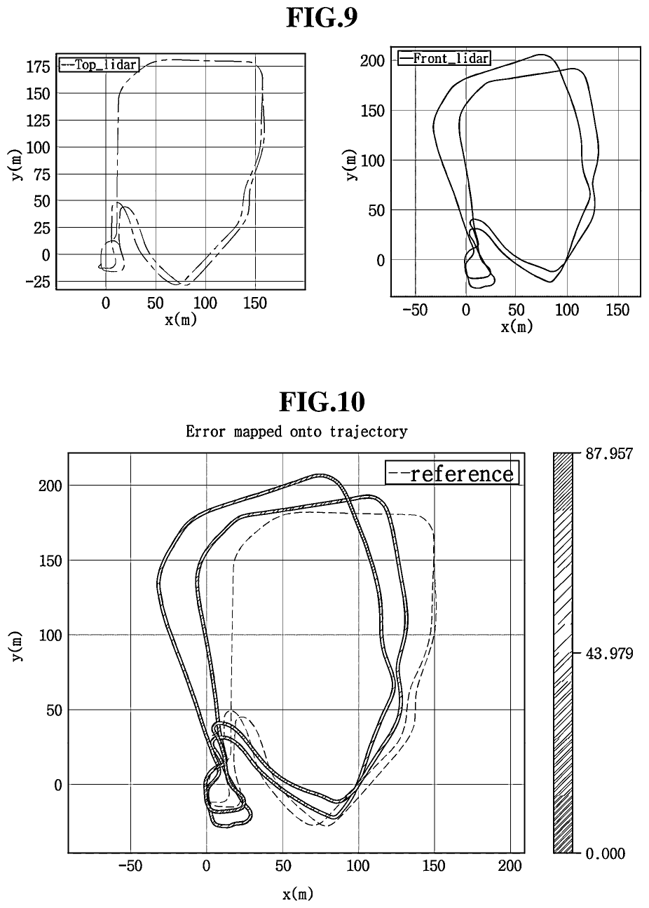

FIG. 9 is a configuration diagram showing a difference in odometry between a single LiDAR (left) of a roof and a dual LiDAR (right) of a bumper, and FIG. 10 is a configuration diagram showing an error of a dual LiDAR compared to a single LiDAR of a roof.

In order to confirm the difference in performance of the dual LiDAR installed on the bumper compared to the single roof LiDAR, an experiment was conducted by driving while making a roof.

In the experiment, a final map created by driving the same route using the vehicle and odometry, the traveling route of the vehicle, were compared.

It can be seen that the LiDAR installed on the roof shows slightly better results. However, considering that two LiDARs installed on the bumper have a narrower field of view by approximately 22% compared to the LiDAR installed on the roof, the result of installing two LiDARs on the bumper shows that fairly high precision is maintained by twisting 14.6° at one corner compared to the LiDAR installed on the roof.

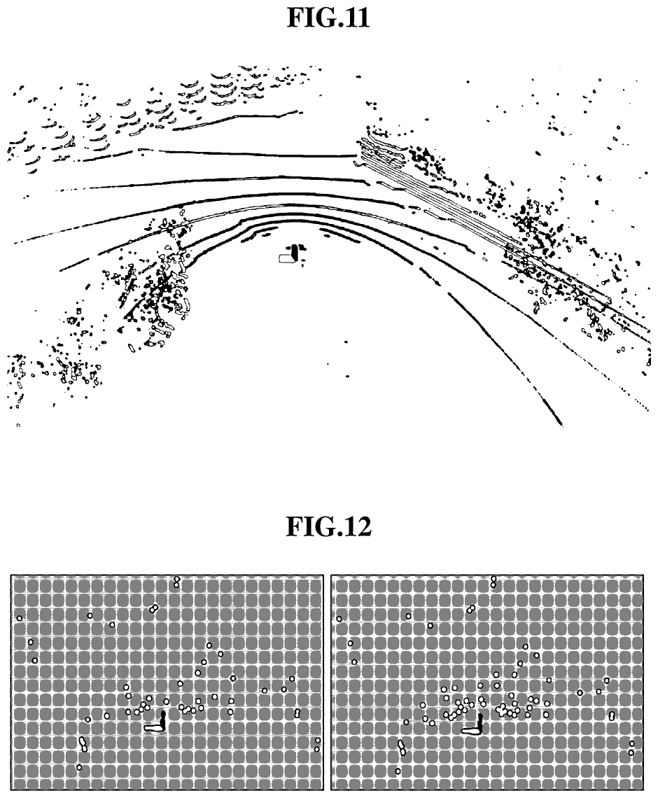

FIG. 11 is a configuration diagram showing LiDAR point cloud raw data for feature change confirmation, and FIG. 12 shows edge: 1, planar: 1 (left), edge: 1, planar: 2 (right) per sub-image (60°).

The difference in odometry according to the feature selection is as follows.

In estimating a position of the vehicle, the output varies according to the change in the number of features detected in the scan, as well as the viewing angle and point of the LiDAR.

In order to confirm a corresponding difference, the LiDAR was mounted on the roof of the vehicle and a change in odometry according to the number of features was measured by changing a detected feature. The number of features actually extracted according to the changed in the feature was measured.

All experiments were conducted in the same place, and there is only a difference between the detected edge and planar. For visualization, a visualization tool called Rviz of ROS was used and displayed below.

As a result of the experiment, it was confirmed that, in the case of outputting 1 edge and 1 planar and in the case of outputting 1 edge and 2 planars per sub-image (60°), the number of planars recognized by each was changed. It was also confirmed that, as the number of planar recognized in the sub-image changed from 1 to 2, the number of planars (yellow dots) in the entire image input for calculation in FIG. 12 increased.

To confirm that the odometry changes as the number of features is varied, SLAM was conducted through the same bag file while varying the number of features.

The results at this time are as shown in Table 4, and it was confirmed that the loop-closer succeeded and showed better results when the number of features was small. In addition, it was confirmed that loop-closer does not run or becomes closer to another point when a feature is recognized above a certain level. Therefore, the number of edges and planar features used for localization was maintained at 2:6 per sub-area (60°).

TABLE 4

| | | Absolute pose error | | | | |
|---|---|---|---|---|---|---|
| Edge | Planar | max | mean | min | rmse | closer |
| 1 | 2 | 14.42 | 6.32 | 0.00 | 7.70 | ∘ |
| | 4 | 15.67 | 6.99 | 0.03 | 8.35 | ∘ |
| | 6 | 15.82 | 7.01 | 0.03 | 8.40 | ∘ |
| | 8 | 15.80 | 6.99 | 0.03 | 8.38 | ∘ |
| | 10 | 15.79 | 6.98 | 0.03 | 8.38 | ∘ |
| 2 | 2 | 14.93 | 6.57 | 0.00 | 7.92 | ∘ |
| | 4 | 14.42 | 6.19 | 0.00 | 7.59 | ∘ |
| | 6 | 14.46 | 6.22 | 0.00 | 7.57 | ∘ |
| | 8 | 14.39 | 6.15 | 0.00 | 7.55 | ∘ |
| | 10 | 15.55 | 7.02 | 0.02 | 8.39 | ∘ |
| 4 | 2 | 14.69 | 6.05 | 0.02 | 7.47 | ∘ |
| | 4 | 14.58 | 6.16 | 0.02 | 7.54 | ∘ |
| | 6 | 14.51 | 6.37 | 0.00 | 7.70 | ∘ |
| | 8 | 46.11 | 14.57 | 0.02 | 19.13 | x |
| | 10 | 14.63 | 6.34 | 0.00 | 7.70 | ∘ |
| 6 | 2 | 14.33 | 6.28 | 0.00 | 7.57 | ∘ |
| | 4 | 74.01 | 23.47 | 0.01 | 32.04 | x |
| | 6 | 72.94 | 23.31 | 0.11 | 31.64 | x |
| | 8 | 14.21 | 5.88 | 0.04 | 7.27 | ∘ |
| | 10 | 14.46 | 6.40 | 0.00 | 7.71 | ∘ |
| 8 | 2 | 14.75 | 6.46 | 0.00 | 7.85 | ∘ |
| | 4 | 14.47 | 6.23 | 0.01 | 7.67 | ∘ |
| | 6 | 14.44 | 6.04 | 0.04 | 7.43 | ∘ |
| | 8 | 73.09 | 23.21 | 0.01 | 31.59 | x |
| | 10 | 74.09 | 23.74 | 0.04 | 31.44 | x |
| | All | 23.08 | 8.77 | 0.02 | 11.12 | ∘ |

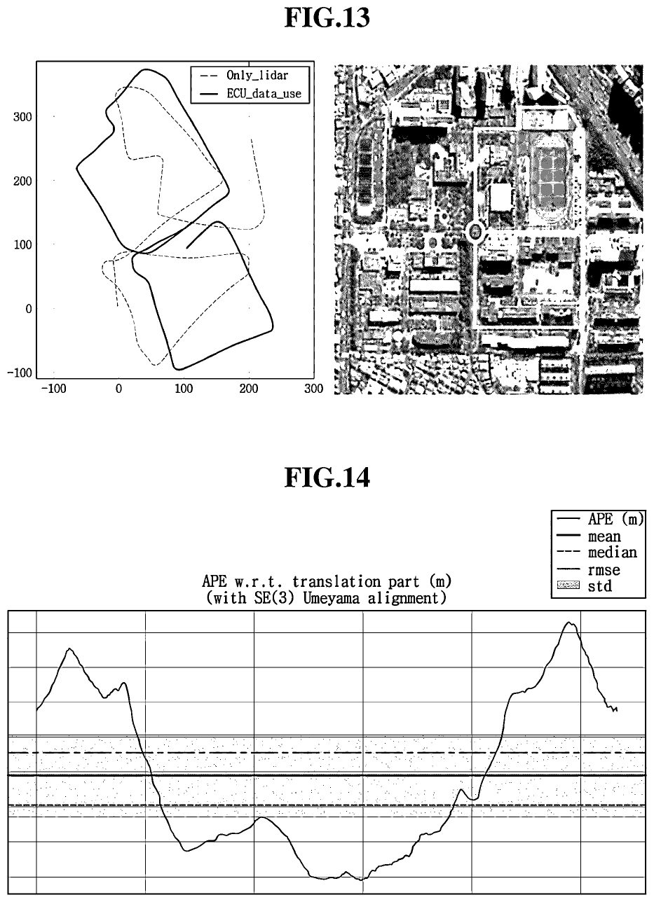

FIG. 13 is a configuration diagram showing a vehicle initial route difference according to the presence or absence of ECU data, and FIG. 14 is a configuration diagram showing a difference in initial values according to the presence or absence of ECU data.

In order to confirm the effect of providing initial values for vehicle movement route estimation using data output from the ECU on the actual vehicle movement route estimation, routes with and without ECU data were compared.

The results of the experiment, which were compared after driving along a pre-determined route, showed an average error of 91 m when the initial position was estimated using only the LiDAR throughout the driving.

A maximum error that occurs is 207 m, and the error mainly occurred in a sharp corner portion. However, when the initial position was estimated using the ECU and the LIDAR together, an average error was 24 m, and a maximum error was 41 m. This error tended to increase when driving at high speed and was corrected when ICP and loop closure were continuously performed by stopping for a sufficient time after driving. However, loop closure through ICP was not possible when too large an error occurred in the initial position.

TABLE 5

| | Initial value | Initial value |
|---|---|---|
| | provided | not provided |
| average error of route | 24.3 m | 91.6 m |
| maximum error of route | 41.8 m | 207.9 m |
| rmse of route | 29.4 m | 110.0 m |

Through the ARM board, input/output of various sensors and algorithm calculation are performed to check a vehicle location and map output. In the experiment, both the dual LiDAR of the bumper and the vehicle ECU data were used. The vehicle was driven in several environments and tested on real roads. The vehicle drove 0.9 km, 4.8 km, and 4.1 km, respectively, and the traveling route and generated map were compared with a satellite map.

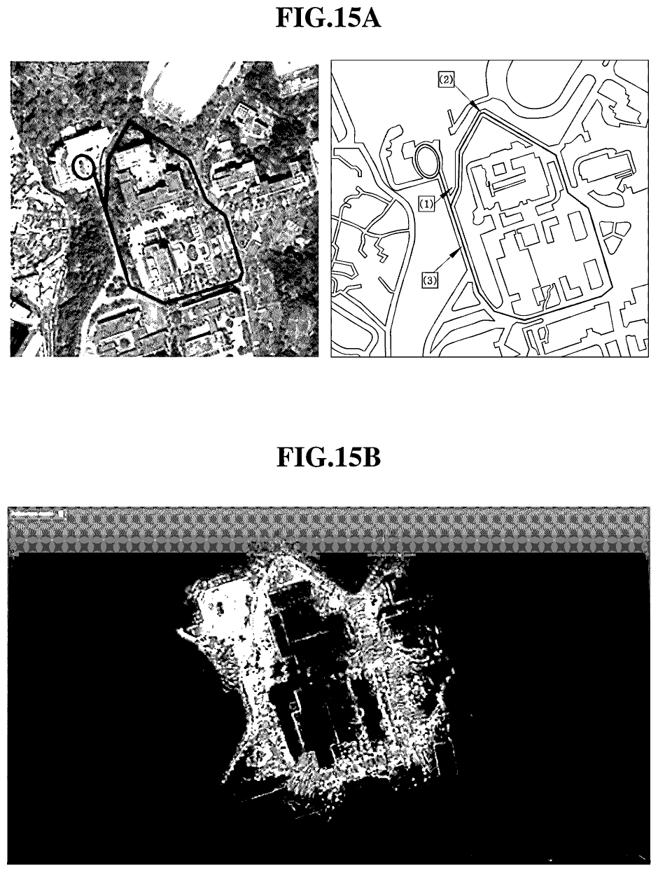

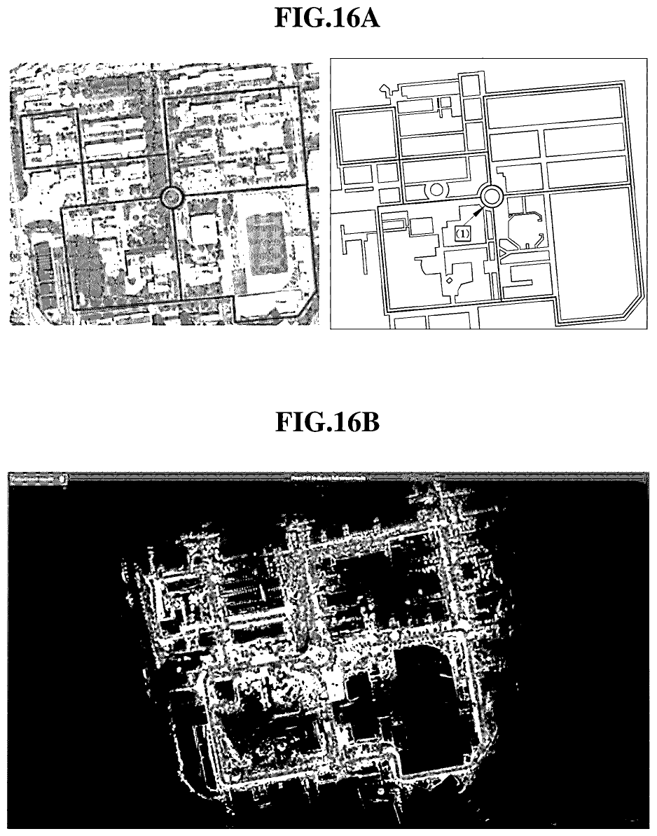

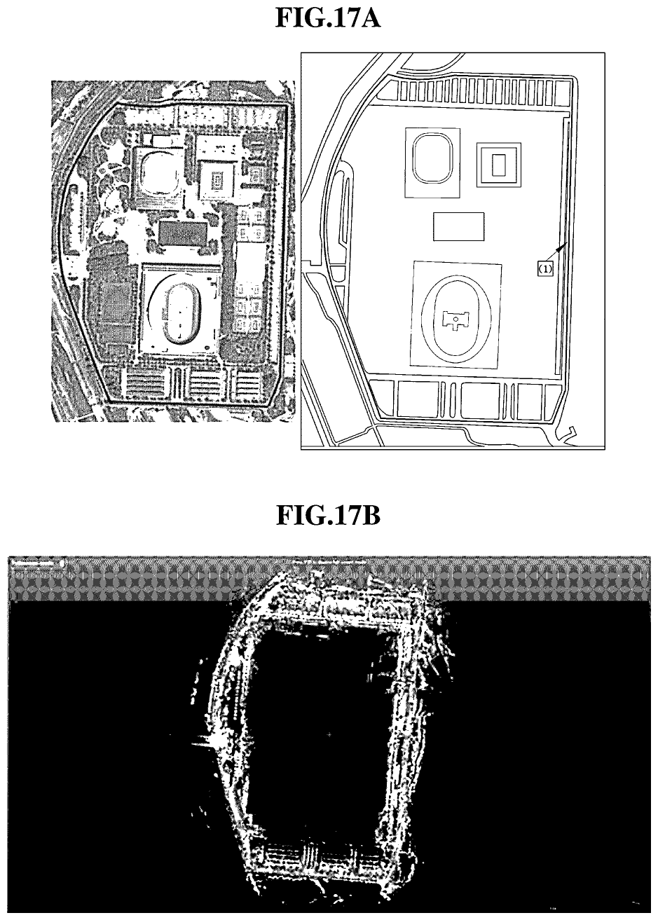

FIGS. 15A and 15B are diagrams of a traveling route and a completed map according to a first embodiment to which the present disclosure is applied, FIGS. 16A and 16B are diagrams of a traveling route and a completed map according to a second embodiment to which the present disclosure is applied, and FIGS. 17A and 17B are diagrams of a traveling route and a completed map according to a third embodiment to which the present disclosure is applied.

Each environment has different characteristics, and in the first embodiment, there is a difference in height on the route and a route with many steep slopes (1) and sharp turns (2) are included.

In addition, there is also a section (3) in which no feature is output because one side is blocked by a wall in some sections.

In the case of the second embodiment, it is flat and 90° rotation occurs frequently. In addition, as all routes overlapped in a central circular rotary (1), it was conducted to test a cumulative error according to each rotation. In the course of driving, loops meet at the central roundabout and some intersections to form a loop closure, so it includes 4 small loops. In the last case, 4.1 km of the longest single run was done at once without a roof closure. Among the routes, the long straight road (1) includes terrain with a very small number of objects.

As a result of the experiment, it was confirmed that the map was output normally in all areas, and it was confirmed that the cumulative error correction on the map operated normally through the loop closure.

In the SLAM system and method for a vehicle using a bumper-mounted dual LiDAR according to the present disclosure described above, by integrating data of two LiDARs mounted on a vehicle bumper, processing the data with one time and a unified coordinate system, receiving the same, extracting information on a traveling route of the vehicle, performing correction using inertial data of the vehicle output from an ECU inside the vehicle, initiating point cloud data of LiDAR along a movement route, a precise map may be created without adding a sensor.

As described above, it will be understood that the present disclosure is implemented in a modified form without departing from the essential characteristics of the present disclosure.

Therefore, the specified embodiments should be considered from an explanatory point of view rather than a limiting point of view, the scope of the present disclosure is shown in the claims rather than the foregoing description, and all differences within the equivalent range are considered to be included in the present disclosure.

### DESCRIPTION OF REFERENCE NUMERALS

| | |
|---|---|
| 10. First LiDAR | 20. Second LiDAR |
| 30. LiDAR data merge unit | 40. ECU |
| 50. SLAM unit | |

What is claimed is:

1. A simultaneous localization and mapping (SLAM) system for a vehicle using a bumper-mounted dual LiDAR, the SLAM system comprising:
a first LiDAR and a second LiDAR mounted on a vehicle bumper to output data for map creation and location recognition;
a LiDAR data merge unit receiving data from the first LiDAR and the second LiDAR, aligning LiDAR times through time synchronization, and then converting the data into a point cloud type and merging the data;
an electronic control unit (ECU) providing inertial data of the vehicle for correcting the data merged in the LiDAR data merge unit; and
an SLAM unit correcting the data merged in the LiDAR data merge unit by using the inertial data of the vehicle received from the ECU to obtain LiDAR odometry for estimating a movement of the vehicle, generating a 3D map of a road on which the vehicle travels, and extracting a location and a traveling route of the vehicle inside a road.

2. The SLAM system of claim 1, wherein
raw data of each of the first LiDAR and the second LiDAR is expressed as one integrated coordinate through point cloud merge, and
a relative position difference between sensors is obtained in an integrated coordinate system and applied to align all point clouds with the sensors in the corrected coordinate system as the origin.

3. The SLAM system of claim 1, wherein
the raw data generated by the first LiDAR and the second LiDAR is received through UDP, and the data of each of the two LiDARs is stored in a buffer, and after times of the LiDARs are aligned through time synchronization, the data is converted into a point cloud type and merged.

4. The SLAM system of claim 1, wherein
the LiDAR odometry is obtained using the point cloud data of the first LiDAR and the second LiDAR, and the odometry is calculated through matching between scans using features detected in LiDAR scans, and
clustering of the received point cloud is performed in order to reduce the number of point clouds used for detection and minimize a load in an embedded board.

5. The SLAM system of claim 4, wherein,
in clustering, a cluster with less than a set number of points is not trusted and not registered, and through this process, a discontinuous noise point is filtered out and only a reliable point is left.

6. The SLAM system of claim 4, wherein,
after clustering the input point cloud,
smoothness of each point is calculated and divided into edge and planar to extract features,
a scan area is divided into a set number of sub-areas and edge and planar extraction is performed for each area to uniformly extract the calculated features, and thereafter,
correspondence of the features between two consecutive scans is calculated to obtain the odometry.

7. The SLAM system of claim 6, wherein
the odometry is obtained by calculating a transform matrix between the features having correspondence, and
at this time, in order to solve the transform matrix as an optimization problem, optimization is performed with edge correspondence and planar correspondence as costs.

8. The SLAM system of claim 7, wherein,
in the optimization process,
a change of a z-axis in the odometry of the vehicle and a roll and pitch are measured through matching between the scans measured by LiDAR,
when calculating a movement of the vehicle in x and y directions on the road, a route estimation value is provided using imu data of the vehicle to complement the odometry calculation, and
data on longitudinal acceleration Tₓ, lateral acceleration T_{y}, and yaw rate θ_{yaw} are output from the ECU of the vehicle, based on which Tₓ, T_{y}, θ_{yaw}, which are x, y-axis movement and yaw rotation of the vehicle, are corrected.

9. A simultaneous localization and mapping (SLAM) method for a vehicle using a bumper-mounted dual LiDAR, the SLAM method comprising:
receiving data for map creation and location recognition from a first LiDAR and a second LiDAR mounted on a vehicle bumper, aligning LiDAR times through time synchronization, and then converting the data into a point cloud type and merging the data;
receiving inertial data of the vehicle and obtaining LiDAR odometry for estimating a movement of the vehicle using point clouds recognized by the first LiDAR and the second LiDAR; and
generating a 3D point cloud map by registering the LiDAR point cloud in a global map according to the obtained odometry by performing SLAM using acceleration data output in a CAN format from an electronic control unit (ECU) inside the vehicle in order to increase precision of odometry and reduce the time required for calculation.

10. The SLAM method of claim 9, wherein
the LiDAR odometry is obtained using the point cloud data of the first LiDAR and the second LiDAR, and the odometry is calculated through matching between scans using features detected in LiDAR scans, and
clustering of the received point cloud is performed in order to reduce the number of point clouds used for detection and minimize a load in an embedded board.

11. The SLAM method of claim 10, wherein,
in clustering, a cluster with less than a set number of points is not trusted and not registered, and through this process, a discontinuous noise point is filtered out and only a reliable point is left.

12. The SLAM method of claim 10, wherein
after clustering the input point cloud,
smoothness of each point is calculated and divided into edge and planar to extract features, a scan area is divided into a set number of sub-areas and an edge and a planar are extracted for each area to uniformly extract the calculated features, and thereafter,
correspondence of the features between two consecutive scans is calculated to obtain the odometry.

13. The SLAM method of claim 12, wherein
the odometry is obtained by calculating a transform matrix between the features having correspondence, and
at this time, in order to solve the transform matrix as an optimization problem, optimization is performed with edge correspondence and planar correspondence as costs.

14. The SLAM method of claim 13, wherein,
in the optimization process,
a change of a z-axis in the odometry of the vehicle and a roll and pitch are measured through matching between the scans measured by LiDAR,
when calculating a movement of the vehicle in x and y directions on the road, a route estimation value is provided using imu data of the vehicle to complement the odometry calculation, and
data on longitudinal acceleration Tₓ, lateral acceleration T_{y}, and θ_{yaw} rate are output from the ECU of the vehicle, based on which Tₓ, T_{y}, θ_{yaw} which are x, y-axis movement and yaw rotation of the vehicle are corrected.
